(19) United States
(12) Patent Application Publication
(10) Pub. No.: US 2010/0082527 A1
(43) Pub. Date: Apr. 1, 2010

(54) DATED METADATA TO SUPPORT MULTIPLE VERSIONS OF USER PROFILES FOR TARGETING OF PERSONALIZED CONTENT

(75) Inventor: Ankur Jain, Cupertino, CA (US)

Correspondence Address: Weaver Austin Villeneuve & Sampson - Yahoo!, P.O. BOX 70250, OAKLAND, CA, 94612-0250, US

(73) Assignee: YAHOO! INC., Sunnyvale, CA (US)

(21) Appl. No.: 12/237,327

(22) Filed: Sep. 24, 2008

(51) Int. Cl. G06F 17/30

(52) U.S. Cl. 707/603; 707/E17.044

(57) ABSTRACT

Profiles are maintained that are usable by a behavioral targeting service. A profile engine processes event indications that are both indicative of interaction by users generally with at least one online service and are specifically indicative of events usable for generating profile data for behavioral targeting to provide personalized content. It is determined which of a plurality of behavioral models to apply to an event indication based on a time associated with the event indication and time periods associated with the behavioral models. The determined behavioral model is applied to determine at least one updated profile. The behavioral targeting service determines which of the plurality of behavioral models to apply to the updated profile data based on a time associated with the updated profile, and processes the updated profile data provided by the profile engine according to the determined behavioral model and, based at least in part on the further processed updated profile data, causes personalized content to be provided in response to the request.

### CROSS-REFERENCE TO RELATED APPLICATIONS

This application is related to co-pending U.S. application Ser. No. ______, filed on an even date herewith, entitled “PRIMARY-SECONDARY CACHING SCHEME TO ENSURE ROBUST PROCESSING TRANSITION DURING MIGRATION AND/OR FAILOVER” (Atty. Docket No.: YAH1P166), and to co-pending U.S. application Ser. No. ______, filed on an even date herewith, entitled “STORAGE OPTIMIZATION FOR UPDATED USER BEHAVIORAL PROFILE SCORES” (Atty. Docket No.: YAH1P167), both of which are incorporated herein by reference in their entirety for all purposes.

### BACKGROUND

FIG. 1, which does not illustrate the present invention, illustrates an architecture of a system in which front end web servers FEa 102a, FEb 102b, FEc 102c, . . . , FEx 102x, including front end web servers handling search events, are producing event data 105 based on incoming user requests 103. There may be many types of events. For example, a web portal such as provided by Yahoo, Inc. may include numerous different “sites,” such as “Sports,” “Finance” and “Search.” These are just a few examples of possible sites and, in practice, the portal may include many more sites.

In the FIG. 1 architecture, the event data 105 is provided to data collectors DC1 108(1) and DC2 108(2) via paths Pa 106a, Pb 106b, Pc 106c and Pd 106d. In general, there may be numerous front end web servers, data collectors and paths; a small number are shown in FIG. 1 and throughout this patent description for simplicity of illustration. The particular paths may be determined according to a path configuration 104, for example, as described in U.S. patent application Ser. No. 11/734,067 (Attorney Docket number YAH1P079), filed on Apr. 11, 2007. U.S. patent application Ser. No. 11/734,067 is incorporated by reference at least for its disclosure of methods to determine path configurations.

The data collectors may be, for example, computers or computer systems in one or more data centers. A data center is a collection of machines (data collector machines) that are co-located (i.e., physically proximally-located). The data centers may be geographically dispersed to, for example, minimize latency of data communication between front end web servers and the data collectors. Within a data center, the network connection between machines is typically fast and reliable, as these connections are maintained within the facility itself. Communication between front end web servers and data centers, and among data centers, is typically over public or quasi-public networks (i.e., the internet).

The events provided from the front end web servers to the data collectors may be provided to one or more data warehouses, using a construct known by some as a “data highway.” In some examples, the data highway has “off ramps” via which various events may be detected and use for functions such as generating scores (or, more generally, profile data) for use in targeting advertisements to users based on past behavior of the users.

### SUMMARY

In accordance with an aspect, a method is provided to maintain profiles usable by a behavioral targeting service. A profile engine processes each of a plurality of event indications, wherein each of the event indications processed are event indications that are both indicative of interaction by users generally with at least one online service and are specifically indicative of events usable for generating profile data for behavioral targeting to provide personalized content. The processing includes to determine which of a plurality of behavioral models to apply to that event indication based on a time associated with the event indication and, for each of the plurality of behavioral models, a time period associated with that behavioral model, apply the determined behavioral model, to determine at least one updated profile, and provide the at least one updated profile data to the behavioral targeting service In response to a request for personalized content received by the behavioral targeting service after the updated profile data has been provided to the behavioral targeting service, determining which of the plurality of behavioral models to apply to the updated profile data based on a time associated with the updated profile, and further processing the updated profile data provided by the profile engine according to the determined behavioral model and, based at least in part on the further processed updated profile data, causing personalized content to be provided in response to the request.

### BRIEF DESCRIPTION OF THE DRAWINGS

FIG. 1, which does not illustrate the present invention, illustrates an architecture of a system in which event indications, generated as a result of user interaction with online services, is provided to data collectors, for providing to persistent storage, such as in a data warehouse.

FIG. 2 illustrates how event indications may be provided to a scoring engine as the event indications are provided for persistent storage.

FIG. 3 broadly illustrates an architecture of a system including a scoring engine that generates updated targeting scores and provides updated scores to online data stores at targeting data center.

FIG. 4 is a diagram of an example targeting-centric logical architecture.

FIGS. 5 and 6 are flowcharts illustrating how the metadata table may be modified to effect a model migration.

FIG. 7 is a flowchart illustrating how the metadata table may be processed to determine a model to apply to detected indicated events and to updated scores.

FIG. 8 is a simplified diagram of a network environment in which specific embodiments of the present invention may be implemented.

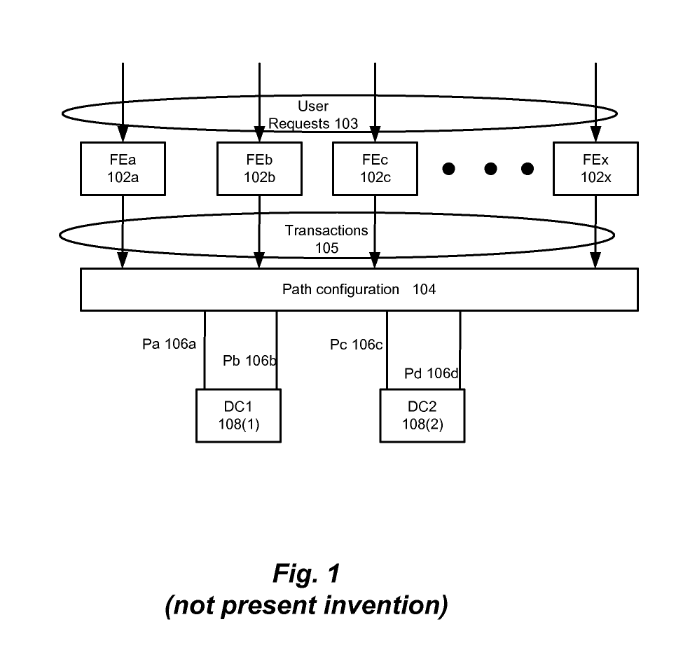

### DETAILED DESCRIPTION

The inventors have realized the desirability of not only centrally computing scores usable for targeting personalized content to users based on past behavior of the users and transmitting updated scores (or, more generally, profile data) to targeting servers for use in targeting users with personalized content. Furthermore, the processing of centrally computing scores and targeting personalized content may operate according to various models, and it may be desirable to change the models (e.g., for testing or updating). When the models are changed, however, it is desirable to ensure that the processing of targeting personalized content employs the same models as the processing for centrally computing scores, when operating on updated scores derived from the same underlying events (i.e., updated scores that have been centrally computed and then are being used for targeting personalized content). To do this, the models may be characterized by metadata usable by the processing for centrally computing scores and by the processing for targeting personalized content, such that each said processing can use the metadata to ensure use of the same models when operating on updated scores derived from the same underlying events.

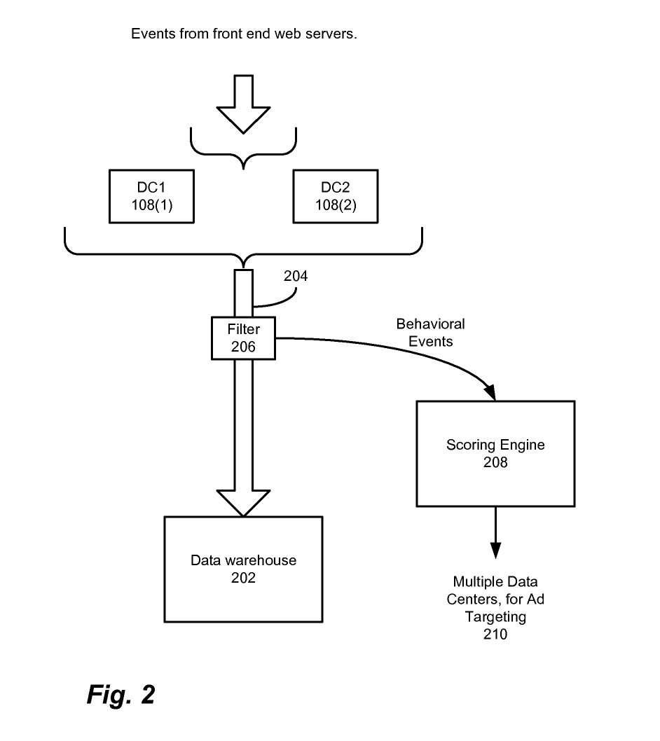

Referring now to FIG. 2, the event data provided to the data collectors DC1 108(1) and DC2 108(2) via paths Pa 106a, Pb 106b, Pc 106c and Pd 106d are further provided to a data warehouse 202 via what may be thought of as a “data highway” 204. For example, every event may be indicated by an event record that includes fields whose contents characterize the event. For example, an event record may include a field whose contents identify a “host name” or “space id” corresponding to a front end server that that generated the event. A “space id” is a unique key that identifies the page contents and category. In addition, the event record may include a “user id” that uniquely correlates to a particular user. Particular events that satisfy particular criteria may be provided from the data highway, as they are provided for persistent storage, using a data offramp. More particularly, the data offramp operates as a selector to select events on the data highway that satisfy the particular criteria.

A scoring engine 208 may then use the “behavioral events” to generate scores for particular users in particular categories, where the generated scores are representative of the behavior of the particular users with respect to those particular categories. Thus, for example, the generated scores may be utilized by targeting functionality to target each particular user with advertisements based on how that user has previously interacted with the sites of the web portal and how that user is presently interacting with the sites of the web portal. This behavioral-based targeting may be used in combination with targeting based on demographic information of the user, as well as geographic information of the user. That is, when a user requests a particular web page, a score for that user, where the score is associated with a category to which the requested particular web page corresponds, may be processed to determine an advertisement to display to that user in association with the requested particular web page. Generally, the better targeted the web page is to the user's past behavior (i.e., to behavior with respect to web pages in the same category as the particular web page requested by the user), the higher a price the web page publisher may command from the advertiser. The general concept of scoring and targeting is well known. The advertisements are served from geographically-distributed data centers 210. The targeting scores are thus provided to multiple data centers 210 for use in the advertisement targeting process.

Furthermore, it may be desired that the models used for scoring and targeting have fine-grained applicability such that, for example, a particular model may be intended for use for particular users, at particular times, and for characterizing particular categories of behavior. In accordance with an example, each model definition has associated with it metadata that characterizes the applicability of that model. Furthermore, as will be described later, the metadata is accessible by the processing for centrally computing scores as well as by the processing for targeting personalized content, such that each said processing can use the metadata to ensure use of the same models when operating on updated scores derived from the same underlying events.

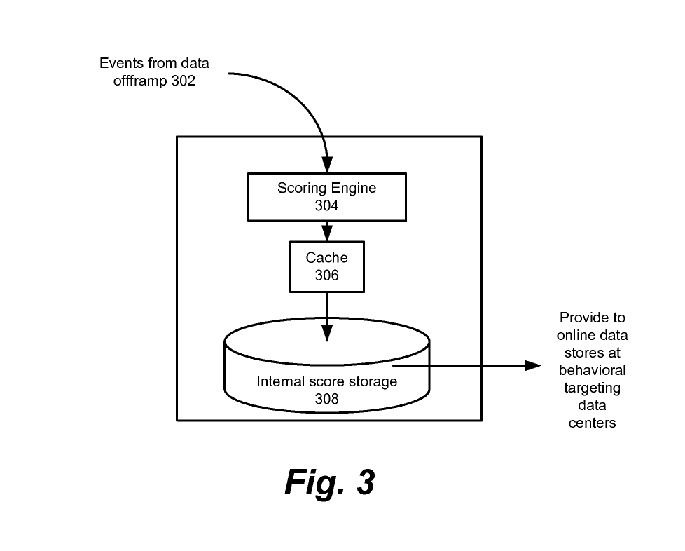

As illustrated in FIG. 3, events 302 may be provided to a scoring engine from a data offramp of a data highway. As discussed in the background, the data highway is how event data provided to data collectors are provided to a data warehouse for persistent storage. The data offramp includes filtering functionality to select those events that meet particular criteria including, generally, events from which it can be determined what is users' behavior with respect to various advertisement targeting categories. Based on the events, scoring engine 304 determines updated category scores for the users, based on previously-determined scores held locally in an internal store 306, and provides the updated scores back to the internal store 306. For example, based on the events, the scoring engine 304 may increase the previously-determined score held in the internal store 306 and provide the increased score back to the internal store 306.

In one example, an update determination function 308 operates to determine if the updated scores meet particular criteria such that the updated scores should be provided to the data centers. For example, the scores may be numbers, and the advertisement targeting model may be such that numbers within a particular range all result in the same advertisement targeting. Put another way, the advertisement targeting may not change until the numerical targeting score crosses a particular threshold between scoring ranges wherein, within each scoring range, the targeting of advertisements or other personalized content does not change. More specific examples of how the update determination function 308 may operate are described in co-pending U.S. application Ser. No. ______, (Atty. Docket No.: YAH1P167).

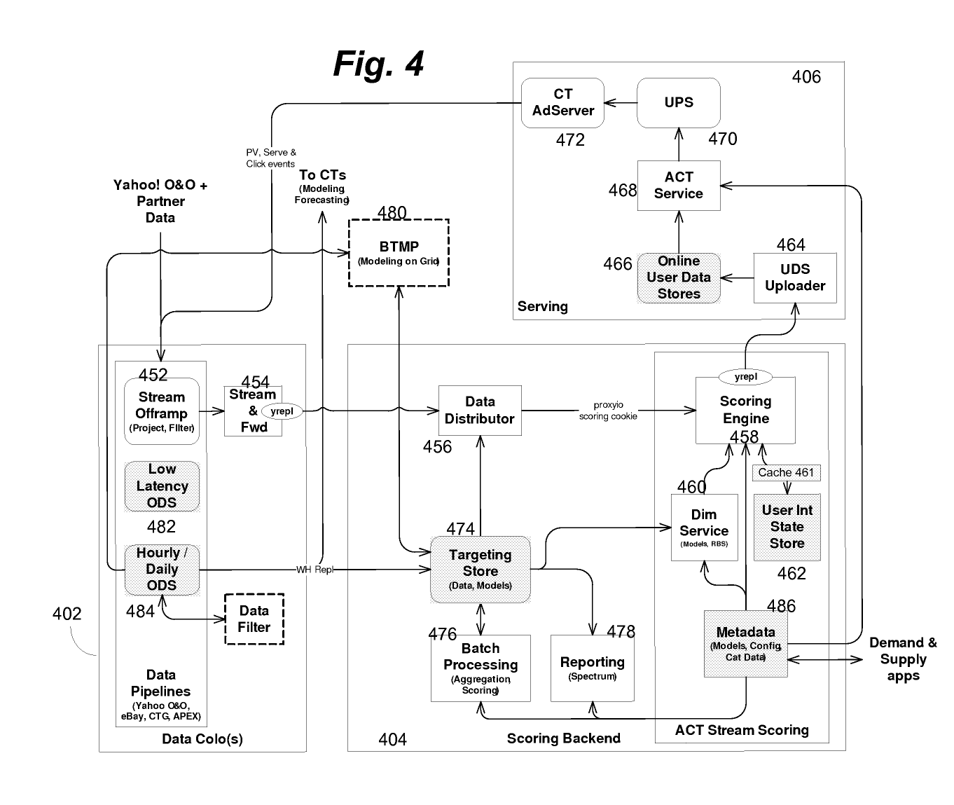

Components that may be used in an example targeting-centric logical architecture are shown in FIG. 4. Broadly speaking, a data center 402 is the source of events being provided for persistent storage. A scoring center 404 processes the events affecting scores used for advertisement targeting, and an advertisement targeting center 406 determines how to target users with advertisements. (In a typical example, the advertisement targeting center 406 is actually multiple distributed advertisement targeting centers 406.) More particularly, a data highway off-ramp 452 of the data center 402 receives data highway events with various parameters that characterize the events. Stream and forward components 454 are co-located with the data highway off-ramps 452, collecting the user activity data from the off-ramps 452 and forwarding the user activity data to a data distributor 456 of the scoring data center 404 using, in this specific example, a “yrepl” event, which is an event that is provided using a particular protocol that is understood by both the data center 402 and the scoring center 404. The data distributor 456 of the scoring center 404 provides the event to a scoring engine 458 of the scoring center 404. The scoring engine 458 queries a dimension service 460 to get information about the scoring model via which to update a score based on the received event. The dimension service 460 holds the model data. The scoring engine 458 then retrieves the current score, whether from local writeback cache 461 or directly from a user internal state store 462 maintained at the scoring center 404.

Metadata 486 provides information about the models, such as which model to use, how to configure the scoring engine 458, etc. More specific examples of the metadata 486 are discussed later. The scoring engine 458 updates the score based on the received event, according to the appropriate scoring model. Then the scoring engine 458 determines if the updated score should be provided to the serving center 406. If the scoring engine 458 determines that the updated score should be provided to the serving center 406, then the updated user score is provided, using a yrepl message, to a user data store uploader 464 of the serving center 406, which handles uploading the updated score to the online data stores 466, where it is available for use by the behavior targeting functionality of the serving centers 406.

Still referring to FIG. 4, in the serving center 506, the ACT (Audience Centric Targeting) Service component 468 applies final decays, score adjustments, combinations, etc to the score components in the user profile, also using the metadata 486 to determine the appropriate scoring model.

The UPS (User Profile Service) component 470 is a brokering service that federates calls for targeting/personalization data across multiple stores and/or services. The CT (Connection Tactic) server component 472 performs ad matching and serving for a Connection Tactic (Guaranteed Delivery, Non guaranteed delivery, etc).

We now turn to the components that are more relevant to the raw data of the received events. For example, the targeting store component 474 is an operational data store containing raw events (pageviews, adviews, adclicks, etc) that are provided from operational data stores for various data collection pipelines from multiple data collection services, that are used by the targeting systems. For example, the low latency operational data store (ODS) 482 and hourly/daily ODS 484 are operational data stores that provide data feeds to various (internal) consumers and to the targeting store component 474. Low latency ODS has data available at latencies of 1 h or less while the hourly/daily ODS provides at latencies of two hours or more. The data retention in this store is typically twenty-eight days or lower. The batch processing component 476 does daily aggregation on this raw data and these daily aggregations are provided to the scoring engine 458 in addition to streaming events. The reporting component 478 is an internal reporting system usable to inspect how well scoring models are performing.

The Behavioral Targeting Modeling Platform (BTMP) 480 is a modeling component that uses data from the targeting store 474 to generate models that may be used for research and/or for generating models for the production system.

Having described an example targeting-centric logical architecture with reference to FIG. 4, we now describe examples of what the metadata may comprise and how the metadata may be organized, to determine what scoring model to apply to particular events. Using the metadata, for example, models may be tested “on-line” for limited numbers of users (i.e., applied only to events for those users), without affecting the personalized content targeting that would occur for the other users. This testing may occur on a fine-grained basis, such as only for particular targeting categories, or at whatever grain of applicability may be accommodated by the metadata. As another example, new models may be phased in, and again this phasing in may be at whatever grain of applicability may be accommodated by the metadata. Thus, for example, the model to determine updated scores for the “sports” category may have been upgraded to v4 (version 4) model for one hundred percent of the users; for the “news” category at v4 model for twenty percent of the users and at v3 model for eighty percent of the users; for the “finance” category at v3 model for all of the users; and for the “food” category at v2 model for all of the users.

In one example, described now with reference to Table 1, the metadata (such as metadata 486, in FIG. 4) may be characterized as a table of data, where each row in the table includes a field for “category,” “user bucket,” “model version,” “start time” and “end time.” In general, the table of metadata is such that it is unambiguous as to which row pertains to a particular event indication. This lack of ambiguity need not be present in the metadata itself. For example, the method of determining which row pertains may function to resolve an ambiguity that might otherwise be present (e.g., using the first row “reached” in processing the table, even though another row might otherwise apply).

TABLE 1

| Category | User Bucket | Model Version | Start | End |
|---|---|---|---|---|
| Autos | 1 . . . 5 | 1.1 | 2008-06-25 | |
| Autos | 1 . . . 5 | 1.0 | 2008-06-01 | |
| Autos | 6 . . . 100 | 1.0 | 2008-06-01 | |
| Sports | 1 . . . 50 | 2.35 | 2008-07-15 | |
| * | * | * | * | |
| * | * | * | * | |
| * | * | * | * | |

Turning now to the particular Table 1 example, the “category” column is an indication of a particular category for which an updated score is being generated. For example, for each user, there may be an updated score for various categories of behavior. Using the Table 1 example, one category of behavior may be a user's behavior with respect to use of online services having to do with automobiles. Another category of behavior may be a user's behavior with respect to use of online services having to do with sports. In general, the category of behavior to which an event indication pertains is directly indicated in, or is discernible from, the event indication.

Furthermore, not only may a category of behavior be an indication of a particular category for which an updated score is being generated but, also, the category of behavior may be an indication of a particular category for which the updated score is being used to determine personalized content to provide to the user. For example, when called on to target personalized content to a particular user, the ACT Service component 468 may determine, for the user, which category has the highest updated score and target personalized content having to do with that category.

Referring still to Table 1, the “User Bucket” column is an indication of for which users a particular row pertains. For example, each user may be associated with a unique identification number, and the “User Bucket” column may indicate that the row pertains to users whose identification numbers fall within a particular range. For example, the first row in Table 1 pertains to users whose identification numbers fall within the range of 1 to 5. In some examples, a more complicated designation of the user bucket may be provided. For example, a particular user bucket need not be limited to particular ranges of users but, rather, may somehow otherwise indicate a unique set of users (or be usable to obtain a unique row pertaining to a particular user, in the context of a particular score update or targeting operation).

The “Model Version” column is a pointer to a scoring model version to use for an event indication that matches to a particular row. In addition, the “Start” column indicates the starting time of an effective period for the “Model Version.” The starting time may actually be a time in the future and, so, this time can be used to control a particular model version to be used in the future, when an event indication (or event indication processing, which may be later than the event indication) equal to or later than the starting time is reached. Similarly, the “End” column indicates an ending time for a particular model version, such that the “Start” and “End” column values together define a period in time that the model version indicated in a row is to be used.

So, referring to the FIG. 4 example architecture, as the scoring engine 458 is to determine an updated score based at least in part on an indicated event, it is determine what model to use in the score updating based on characteristics of the event and based on metadata 486 which may be organized, for example, as described above in Table 1 or in another appropriate manner via which it can be determined what model to use. As the score is updated, the data stored in the online user data stores 466 is stored with an indication of the time the score was last updated.

Besides using this information for determining the appropriate model to be used by the ACT service 468 to process the updated score to determine personalized content to target to a user, this information is otherwise used by the ACT service 468 to check for updated scores that are “stale” and should therefore not be used in targeting personalized content. This update time information may also be used to determine decays to apply to the updated scores based on a passage of time since the score was updated. To determine the appropriate model to use in processing by the ACT service 468 to determine personalized content, the metadata 486 may be accessed and processed in a manner similar to that described above with respect to the scoring engine 458, using the indication of the time the score was last updated. However, as also mentioned above with respect to the scoring engine 458, there may be a variety of appropriate manners in which the model to use in processing the updated scores may be determined.

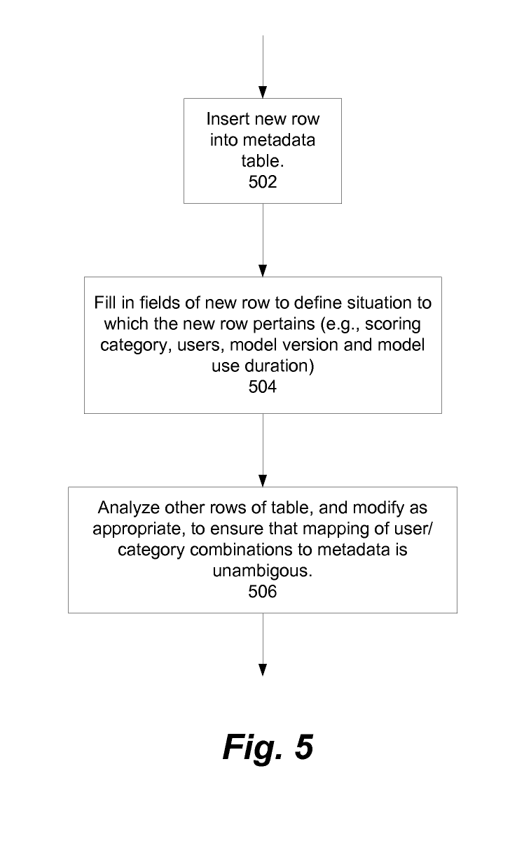

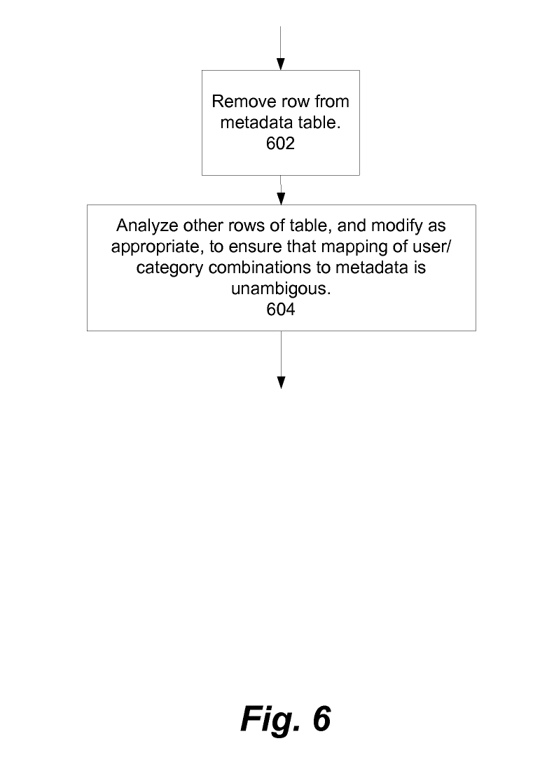

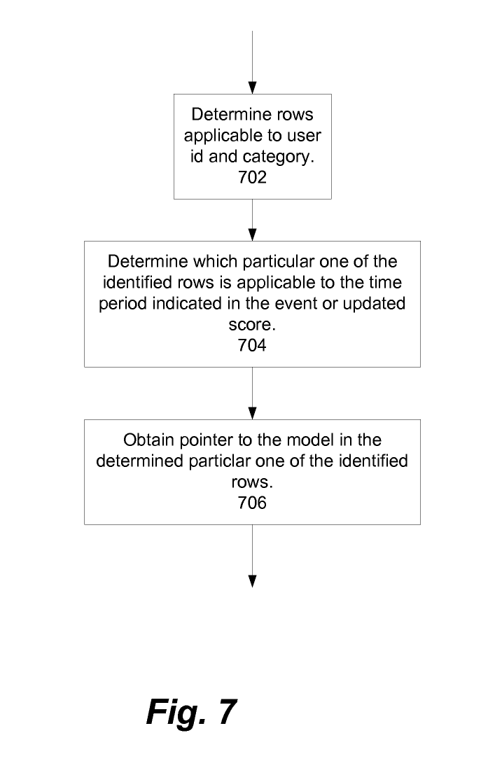

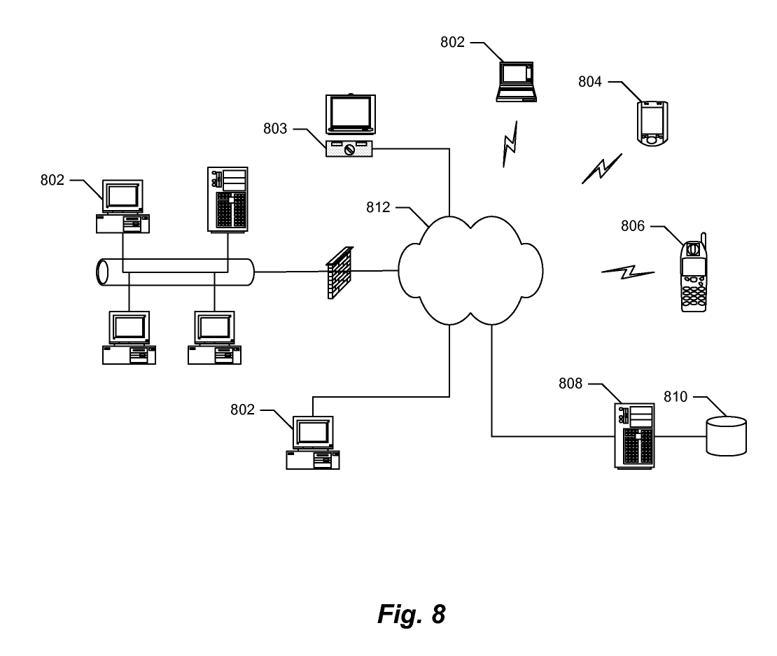

We now discuss, with reference to FIGS. 5 and 6, an example of how the metadata table may be modified to effect a model migration. Thereafter, we discuss, with reference to FIG. 7, an example of how the metadata table may be accessed (either by the scoring engine or by the targeting service). Turning now to FIG. 5, at 502, a row is added to the metadata table. At 504, the fields of the row are filled in with values appropriate to a model to which it is desired to migrate processing of at least some of the indicated events (i.e., to indicate the model and the events to be processed according to the model). At 506, other rows of the table are analyzed, and values modified as appropriate, to ensure that the mapping of user/category combinations to metadata rows is unambiguous and correctly accomplishes the desired model migration.

As shown in FIG. 6, in some situations, effecting model migration may be accomplished by deleting metadata from the metadata table. At 602, a row is removed from the metadata table. At 604, other rows of the table are analyzed, and values modified as appropriate, to ensure that the mapping of user/category combinations to metadata rows is unambiguous and correctly accomplishes the desired model migration.

Referring now to FIG. 7, we describe an example of how the metadata table may be accessed to determine a scoring model to apply to a given indicated event or updated score. At 702, given the user identification and category indicated in an event indication or updated score, all of the rows applicable to this user identification and category indication are identified. There are a variety of manners in which the rows may be identified, such as by hashing, having the table stored in a content-addressable memory, etc. At 704, it is determined which particular one of the identified rows is applicable to the time period indicated in the event or updated score. At 706, a pointer is obtained to the model indicated in the determined particular one of the identified rows. This is the model to be applied to the indicated event (e.g., by the FIG. 4 scoring engine 458) or updated score (e.g., by the FIG. 4 ACT service 468).

Embodiments of the present invention may be employed to determine scoring models in a wide variety of computing contexts. For example, as illustrated in FIG. 7, implementations are contemplated in which users may interact with a diverse network environment via any type of computer (e.g., desktop, laptop, tablet, etc.) 702, media computing platforms 703 (e.g., cable and satellite set top boxes and digital video recorders), handheld computing devices (e.g., PDAs) 704, cell phones 706, or any other type of computing or communication platform.

According to various embodiments, applications may be executed locally, remotely or a combination of both. The remote aspect is illustrated in FIG. 7 by server 708 and data store 710 which, as will be understood, may correspond to multiple distributed devices and data stores.

The various aspects of the invention may also be practiced in a wide variety of network environments (represented by network 712) including, for example, TCP/IP-based networks, telecommunications networks, wireless networks, etc. In addition, the computer program instructions with which embodiments of the invention are implemented may be stored in any type of tangible computer-readable media, and may be executed according to a variety of computing models including, for example, on a stand-alone computing device, or according to a distributed computing model in which various of the functionalities described herein may be effected or employed at different locations.

1. A method of maintaining profiles usable by a behavioral targeting service, comprising:
processing event indications, wherein the event indications being processed are indicative of interaction by users generally with at least one online service, wherein some of the event indications are indicative of events usable for generating profile data for behavioral targeting to provide personalized content, the processing of event indications to detect event indications that are indicative of events usable for generating profile data for behavioral targeting;
by a profile engine,
processing each detected event indication to
determine which of a plurality of behavioral models to apply to that detected event indication based on a time associated with the detected event indication and, for each of the plurality of behavioral models, a time period associated with that behavioral model,
apply the determined behavioral model, to determine at least one updated profile, and
provide the at least one updated profile data to the behavioral targeting service;
in response to a request for personalized content received by the behavioral targeting service after the updated profile data has been provided to the behavioral targeting service, determining which of the plurality of behavioral models to apply to the updated profile data based on a time associated with the updated profile, and further processing the updated profile data provided by the profile engine according to the determined behavioral model and, based at least in part on the further processed updated profile data, causing personalized content to be provided in response to the request.

2. The method of claim 1, wherein:
determining which of a plurality of behavioral models to apply to that detected event indication and determining which of the plurality of behavioral models to apply to the updated profile data includes processing model applicability metadata that characterizes the applicability of the models to the detected event indications and to the updated profile data.

3. The method of claim 2, wherein:
processing the model applicability metadata includes matching a time associated with the detected event indication and a time associated with the updated profile data to time indications included in the model applicability metadata.

4. The method of claim 2, wherein:
processing the model applicability metadata includes matching a user associated with the detected event indication and a user associated with the updated profile data to user indications included in the model applicability metadata

5. The method of claim 2, further comprising:
modifying the metadata such that indicated events and updated profile data that would have been processed by applying a first particular model are instead processed by applying a second particular model.

6. A method of maintaining profiles usable by a behavioral targeting service, comprising:
by a profile engine,
processing each of a plurality of event indications, wherein each of the event indications processed are event indications that are both indicative of interaction by users generally with at least one online service and are specifically indicative of events usable for generating profile data for behavioral targeting to provide personalized content, the processing including to
determine which of a plurality of behavioral models to apply to that event indication based on a time associated with the event indication and, for each of the plurality of behavioral models, a time period associated with that behavioral model,
apply the determined behavioral model, to determine at least one updated profile, and
provide the at least one updated profile data to the behavioral targeting service; and
in response to a request for personalized content received by the behavioral targeting service after the updated profile data has been provided to the behavioral targeting service, determining which of the plurality of behavioral models to apply to the updated profile data based on a time associated with the updated profile, and further processing the updated profile data provided by the profile engine according to the determined behavioral model and, based at least in part on the further processed updated profile data, causing personalized content to be provided in response to the request.

7. The method of claim 6, wherein:
determining which of a plurality of behavioral models to apply to that detected event indication and determining which of the plurality of behavioral models to apply to the updated profile data includes processing model applicability metadata that characterizes the applicability of the models to the detected event indications and to the updated profile data.

8. The method of claim 7, wherein:
processing the model applicability metadata includes matching a time associated with the detected event indication and a time associated with the updated profile data to time indications included in the model applicability metadata.

9. The method of claim 7, wherein:
processing the model applicability metadata includes matching a user associated with the detected event indication and a user associated with the updated profile data to user indications included in the model applicability metadata

10. The method of claim 7, further comprising:
modifying the metadata such that indicated events and updated profile data that would have been processed by applying a first particular model are instead processed by applying a second particular model.

11. A behavioral targeting system, comprising:
a profile engine configured to
process each of a plurality of event indications, wherein each of the event indications processed are event indications that are both indicative of interaction by users generally with at least one online service and are specifically indicative of events usable for generating profile data for behavioral targeting to provide personalized content, the processing including to
determine which of a plurality of behavioral models to apply to that event indication based on a time associated with the event indication and, for each of the plurality of behavioral models, a time period associated with that behavioral model,
apply the determined behavioral model, to determine at least one updated profile, and
provide the at least one updated profile data to the behavioral targeting service; and
a behavioral targeting service configured to respond to a request for personalized content received by the behavioral targeting service after the updated profile data has been provided to the behavioral targeting service by
determining which of the plurality of behavioral models to apply to the updated profile data based on a time associated with the updated profile,
processing the updated profile data provided by the profile engine according to the determined behavioral model, and
based at least in part on the further processed updated profile data, causing personalized content to be provided in response to the request.

12. The system of claim 11, wherein:
determining which of a plurality of behavioral models to apply to that detected event indication and determining which of the plurality of behavioral models to apply to the updated profile data includes processing model applicability metadata that characterizes the applicability of the models to the detected event indications and to the updated profile data.

13. The system of claim 12, wherein:
processing the model applicability metadata includes matching a time associated with the detected event indication and a time associated with the updated profile data to time indications included in the model applicability metadata.

14. The system of claim 12, wherein:
processing the model applicability metadata includes matching a user associated with the detected event indication and a user associated with the updated profile data to user indications included in the model applicability metadata

15. The system of claim 12, further comprising:
modifying the metadata such that indicated events and updated profile data that would have been processed by applying a first particular model are instead processed by applying a second particular model.
